(19) United States
(12) Patent Application Publication
(10) Pub. No.: US 2025/0210895 A1
(43) Pub. Date: Jun. 26, 2025

(54) CONNECTOR ASSEMBLY AND ELECTRONIC DEVICE

(71) Applicant: Heshan Deren Electronic Technology Co., Ltd., Jiangmen (CN)

(72) Inventors: Zhudong Huo, Jiangmen (CN); Haibo Chen, Jiangmen (CN)

(21) Appl. No.: 18/752,776

(22) Filed: Jun. 24, 2024

(30) Foreign Application Priority Data
Dec. 21, 2023 (CN) 202311778914.6

(51) Int. Cl. H01R 12/72; H01R 12/70

(52) U.S. Cl. CPC H01R 12/722; H01R 12/7047; H01R 12/707

(57) ABSTRACT

The present disclosure relates to the technical field of connectors, and in particular, relates to a connector assembly and an electronic device. The connector assembly includes a connector and an adapter. The connector includes a base and a first terminal cluster, wherein the first terminal is arranged on the base. The adapter includes a body and a second terminal cluster, wherein the second terminal cluster is arranged on the body. When the adapter is plugged into the connector, the first terminal cluster is docked with the second terminal cluster. Where the adapter fails, the adapter only needs to be directly removed from the connector, with no need of desoldering, such that the problem of complicated replacement of an interface of the electronic device and a low success rate of the replacement is effectively solved, and hence the efficiency and success rate of the replacement are improved.

### CROSS REFERENCE TO RELATED APPLICATIONS

The present application claims the benefit of Chinese Patent Application No. 202311778914.6 filed on Dec. 21, 2023, the contents of which are incorporated herein by reference in their entirety.

### TECHNICAL FIELD

Embodiments of the present disclosure relate to the technical field of connectors, and in particular, relate to a connector assembly and an electronic device.

### BACKGROUND

With the development of electronic technology, an increasing number of electronic devices are interactively used frequently by people, such as mobile phones, computers, tablets, monitors, televisions, or the like. Electronic devices typically feature interfaces for transmitting electrical signals with the outside, such as USB interfaces, type-C interfaces, or the like.

In the process of implementing the embodiments of the present disclosure, the inventors have found that due to an increase of the use frequency of the electronic devices, plug and unplug operations between the interfaces of electronic devices and external plugs also increase, which significantly increases the probability of interface damages. In the related art, an interface of an electronic device is typically secured and connected by soldering the interface over a printed circuit board. However, where the interface fails, the entire printed circuit board needs to be removed and then the failed interface is desoldered and removed from the printed circuit board, and then a new interface is soldered thereon. During this process, the replacement is complicated and the repair efficiency is low; and further, the success rate of the displacement is low.

### SUMMARY

Embodiments of the present disclosure provide a connector assembly and an electronic device, which are capable of effectively solving the problem of complicated replacement of an interface of the electronic device and a low success rate of the replacement, and hence improving the efficiency and success rate of the replacement.

To solve the above technical problem, one technical solution employed by the embodiments of the present disclosure is a connector assembly. The connector assembly includes a connector and an adapter. The connector includes a base and a first terminal cluster, wherein the first terminal is arranged on the base. The adapter includes a body and a second terminal cluster, wherein the second terminal cluster is arranged on the body. When the adapter is plugged into the connector, the first terminal cluster is docked with the second terminal cluster.

In some embodiments, the first terminal cluster includes a first terminal set and a second terminal set, wherein a first slot is arranged in the base, and the first terminal set and the second terminal set are both partially positioned in the first slot and are both configured to be electrically connected to an external printed circuit board; and the second terminal cluster includes a third terminal set and a fourth terminal set, wherein the third terminal set and the fourth terminal set are both arranged on the body, and the adapter includes a first end portion configured to be plugged into the base and a second end portion configured to receive an external plug; wherein when the first end portion of the adapter is plugged into the first slot, the first terminal set is docked with the third terminal set, and the second terminal set is docked with the fourth terminal set.

In some embodiments, a first limiting boss and a second limiting boss are arranged on the base, wherein along a first direction, the first limiting boss is spaced apart from the second limiting boss, and the first slot is at least partially positioned between the first limiting boss and the second limiting boss.

In some embodiments, a plurality of gap slots are arranged in the first limiting boss, and the first terminal set includes a plurality of first connection terminals, wherein each of the first connection terminals is correspondingly arranged in one of the first gap slots and includes a first pin portion, a first securing portion, and a first docking portion that are connected, the first pin portion extending through the first slot, the first securing portion being connected to the base, and the first docking portion being arranged in the first gap slot and partially protruding from a surface of the first limiting boss.

In some embodiments, a plurality of gap slots are arranged in the second limiting boss, and the second terminal set includes a plurality of second connection terminals, wherein each of the second connection terminals is correspondingly arranged in one of the second gap slots and includes a second pin portion, a second securing portion, and a second docking portion that are connected, the second pin portion extending through the first slot, the second securing portion being connected to the base, and the second docking portion being arranged in the second gap slot and partially protruding from a surface of the second limiting boss.

In some embodiments, the first docking portion is elastically deformable with respect to the first limiting boss, and/or the second docking portion is elastically deformable with respect to the second limiting boss.

In some embodiments, along a second direction, the first limiting boss and the second limiting boss are staggered, wherein the first direction is perpendicular to the second direction; and an inclined portion is arranged on the first limiting boss, wherein the inclined portion is close to an opening of the first slot and is configured to cause the first end portion of the adapter to be plugged into the first slot at an angle.

In some embodiments, a third limiting boss and a fourth limiting boss are further arranged on the base, wherein along a third direction, the third limiting boss and the fourth limiting boss are spaced apart on two sides of the second limiting boss, wherein the first direction, the second direction, and the third direction are perpendicular to each other pairwise.

In some embodiments, the connector further includes a first securing housing, wherein the first securing housing is connected to the base, and is configured to secure the base to an external printed circuit board.

In some embodiments, the third terminal set includes a plurality of third connection terminals, wherein the plurality of third connection terminals are spaced apart along a third direction, and a first end of the third connection terminal is arranged at the first end portion of the adapter and a second end of the third connection terminal is arranged at the second end portion of the adapter.

In some embodiments, the fourth terminal set includes a plurality of fourth connection terminals, wherein the plurality of fourth connection terminals are spaced apart along a third direction, and a first end of the fourth connection terminal is arranged at the first end portion of the adapter and a second end of the fourth connection terminal is arranged at the second end portion of the adapter.

In some embodiments a second slot is arranged in the body, wherein the third terminal set and the fourth terminal set are partially positioned in the second slot to from the second end portion of the adapter, and the second slot is configured to allow positioning and plugging of an external plug into the second end portion of the adapter.

In some embodiments, the adapter further includes a second securing housing, wherein the second securing housing is connected to the body, and is configured to secure the body to an external printed circuit board.

In some embodiments, a locking slot is arranged in an inner wall of the first slot, wherein a locking portion is arranged at the first end portion of the adapter, wherein the locking portion is plugged into the locking slot to restrict a relative movement of the adapter with respect to the connector along a second direction.

To solve the above technical problem, another technical solution employed by the embodiments of the present disclosure is a connector assembly. The connector assembly includes a connector and an adapter. The connector is configured to be soldered to an external printed circuit board, and a first end portion of the adapter is configured to be docked with the adapter and a second end portion of the adapter is configured to be plug-and-play connected to an external plug.

To solve the above technical problem, still another technical solution employed by the embodiments of the present disclosure is an electronic device. The electronic device includes a printed circuit board and the connector assembly as described above.

The connector assembly according to the present disclosure includes a connector and an adapter. The connector includes a base and a first terminal cluster, wherein the first terminal is arranged on the base. The adapter includes a body and a second terminal cluster, wherein the second terminal cluster is arranged on the body. When the adapter is plugged into the connector, the first terminal cluster is docked with the second terminal cluster. By the above structure, where the adapter fails, the adapter only needs to be directly removed from the connector, with no need of desoldering, even less necessary to remove the printed circuit board from the electronic device, such that the problem of complicated replacement of an interface of the electronic device and a low success rate of the replacement is effectively solved, and hence the efficiency and success rate of the replacement are improved.

### BRIEF DESCRIPTION OF THE DRAWINGS

For clearer descriptions of the technical solutions according to the embodiments of the present disclosure, hereinafter brief description is given with reference to the accompanying drawings for illustrating the embodiments. In all the accompanying drawings, like elements or parts are generally denoted by like reference numerals. In the accompanying drawings, various elements or parts are not necessarily drawn according to the actual scale.

FIG. 1 is a schematic assembly diagram of a connector assembly according to some embodiments of the present disclosure;

FIG. 2 is an exploded view of the connector assembly according to some embodiments of the present disclosure;

FIG. 3 is an exploded view of the connector assembly along an A-A line in FIG. 1 according to some embodiments of the present disclosure;

FIG. 4 is a sectional view of a connector in the connector assembly along the A-A line in FIG. 1 according to some embodiments of the present disclosure;

FIG. 5 is a sectional view of an assembly process of the connector assembly according to some embodiments of the present disclosure;

FIG. 6 is an enlarged view of a part B in FIG. 2 of an adapter of the connector assembly according to some embodiments of the present disclosure;

FIG. 7 is an enlarged view of a part C in FIG. 2 of a connector of the connector assembly according to some embodiments of the present disclosure;

FIG. 8 is a schematic diagram of the adapter of the connector assembly according to some embodiments of the present disclosure; and

FIG. 9 is a schematic assembly diagram, from another perspective view, of the adapter of the connector assembly according to some embodiments of the present disclosure.

### DETAILED DESCRIPTION

For better understanding of the present disclosure, the present disclosure is described in detail with reference to attached drawings and specific embodiments. It should be noted that, when an element is defined as “being secured or fixed to” another element, the element may be directly positioned on the element or one or more centered elements may be present therebetween. When an element is defined as “being connected or coupled to” another element, the element may be directly connected or coupled to the element or one or more centered elements may be present therebetween. In the description of the present disclosure, it should be understood that the terms “upper,” “lower,” “inner,” “outer,” “vertical,” “horizontal,” and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure. In addition, the terms “first,” “second,” and the like are merely for the illustration purpose, and shall not be construed as indicating or implying a relative importance.

Unless the context clearly requires otherwise, throughout the specification and the claims, technical and scientific terms used herein denote the meaning as commonly understood by a person skilled in the art. Additionally, the terms used in the specification of the present disclosure are merely for describing the objects of the specific embodiments, and are not intended to limit the present disclosure. As used herein, the term “and/or” in reference to a list of one or more items covers all of the following interpretations of the term: any of the items in the list, all of the items in the list and any combination of the items in the list.

In addition, technical features involved in various embodiments of the present disclosure described hereinafter may be combined as long as these technical features are not in conflict.

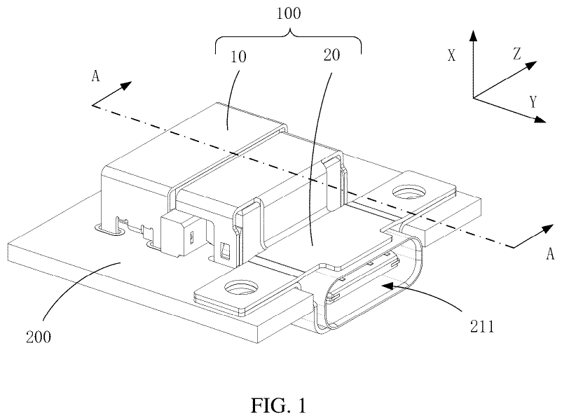

In the related art, an interface of an electronic device is typically secured and connected by soldering the interface over a printed circuit board 200. However, where the interface fails, the entire printed circuit board 200 needs to be removed from the electronic device and then the failed interface is desoldered and removed from the printed circuit board, and then a new interface is soldered thereon. During this process, the replacement is complicated and the repair efficiency is low; and further, high-temperature damages may be caused to the other devices on the printed circuit board 200 during the soldering, or pins on the printed circuit board 200 are damaged, and consequently the success rate of the displacement is low. Referring to FIG. 1 to FIG. 6, the present disclosure provides a connector assembly 100 applicable to an electronic device. The connector assembly 100 includes a connector 10 and an adapter 20. The connector 10 is configured to be soldered and secured to the printed circuit board 200 of the electronic device. The adapter 20 is detachably plugged into the connector 10. An electrical signal connection is achieved between a terminal in the adapter 20 and a terminal of the connector 10 by docking, such that the problem that the terminals are hard to be detached from each other in the case of soldering. The adapter 20 is configured to receive an external plug. Where the adapter 20 fails, the adapter 20 only needs to be directly removed from the connector 10, with no need of desoldering, even less necessary to remove the printed circuit board 200 from the electronic device, such that the problem of complicated replacement of an interface of the electronic device and a low success rate of the replacement is effectively solved, and hence the efficiency and success rate of the replacement are improved.

In some embodiments, referring to FIG. 1 to FIG. 3, the connector assembly 100 includes a connector 10 and an adapter 20. The connector 10 is configured to be soldered to an external printed circuit board, and a first end portion 20a of the adapter 20 is configured to be docked with the connector 10 and a second end portion 20b of the adapter 20 is configured to be plug-and-play connected to an external plug. As an example, the connector 10 includes a base 11 and a first terminal cluster 11a. The first terminal cluster 11a is arranged on the base 11. The adapter 20 includes a body 21 and a second terminal cluster 21a. The second terminal cluster 21a is arranged on the body 21. When the adapter 20 is plugged into the connector 10, the first terminal cluster 11a is docked with the second terminal cluster 21a to implement signal connection. The docking connection between the two terminal sets facilitates a quick removal thereof, and thus the removal efficiency is improved.

It should be noted that the first end portion 20a of the adapter 20 may be a male end or a female end, and correspondingly, the connector 10 is a female end or a male end. The second end portion 20b of the adapter 20 may be a female end or a male end, and correspondingly the external plug is a male end or a female end. One of the two end portions of the adapter 20 may be a male end and the other of the two end portions may be a female end. Alternatively, the two end portions may be both male ends or both female ends. The structures of the two end portions of the adapter 20 may be designed according to actual manufacture and application needs.

It should be noted that the first terminal cluster 11a and the second terminal cluster 21a are designed to achieve transmission of electrical signals between the printed circuit board and an external plug. In actual production and application, the number of first terminal clusters 11a and the number of second terminal clusters 21a may be determined according to the types and the number of electrical signals transmitted. For example, the number of first terminal clusters 11a may be one, two, three, or more than three. Likewise, the number of second terminal clusters 21a may be one, two, three, or more than three. Nevertheless, the number of terminals in the first terminal cluster 11a may also be one, two, three, or more than three. Likewise, the number of terminals in the second terminal cluster 21a may also be one, two, three, or more than three.

Hereinafter, description is given using a scenario where the first end portion 20a of the adapter 20 is a male end, the second end portion 20b of the adapter 20 is a female end, and the first terminal cluster 11a and the second terminal cluster 21a each include two terminal sets as an example. Referring to FIG. 1, the first terminal cluster 11a includes a first terminal set 12 and a second terminal set 13. A first slot 111 is arranged in the base 11, and the first terminal set 12 and the second terminal set 13 are both partially positioned in the first slot 111 and are both configured to be electrically connected to an external printed circuit board 200. The second terminal cluster 21a includes a third terminal set 22 and a fourth terminal set 23. The third terminal set 22 and the fourth terminal set 23 are both arranged on the body 21. A first end of the adapter 20 is the first end portion 20a, and the first end portion 20a is configured to be plugged into the first slot 111 to achieve an electrical signal connection. A send end of the adapter 20 is the second end portion 20b, and the second end portion 20b is configured to be plug-connected to an external plug to achieve an electrical signal connection.

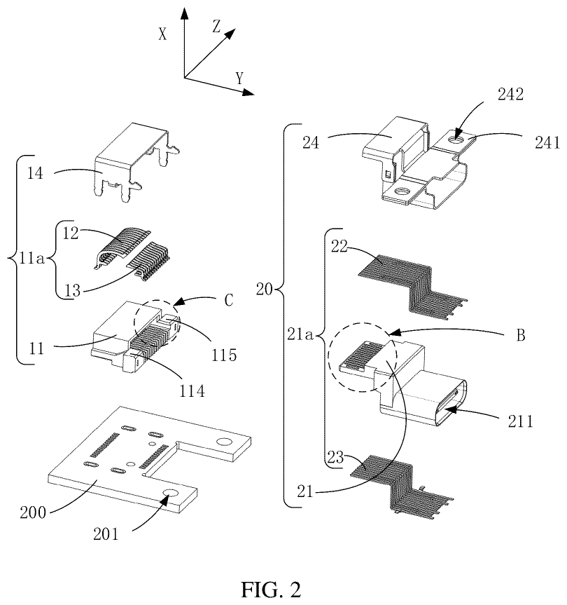

Referring to FIG. 2, when the first end portion 20a is plugged into the first slot 111, the first terminal set 12 is docked with the third terminal set 22 to achieve an electrical signal connection, and the second terminal set 13 is docked with the fourth terminal set 23 to achieve an electrical signal connection. During normal operation of the electronic device, the connector 10 remains connected to the adapter 20, almost with no need of plugging and unplugging, and the electronic device is plug-connected to an external plug via the adapter 20 to achieve transmission of electrical signals. When the adapter 20 fails and needs to be replaced, since the first terminal set 12 is directly docked with the third terminal set 22, and the second terminal set 13 is directly docked with the fourth terminal set 23, the adapter 20 may be directly unplugged and removed with respect to the connector 10, and then a new adapter 20 is plugged into the connector 10. Replacement steps are greatly simplified, and the success rate of the replacement is greatly improved.

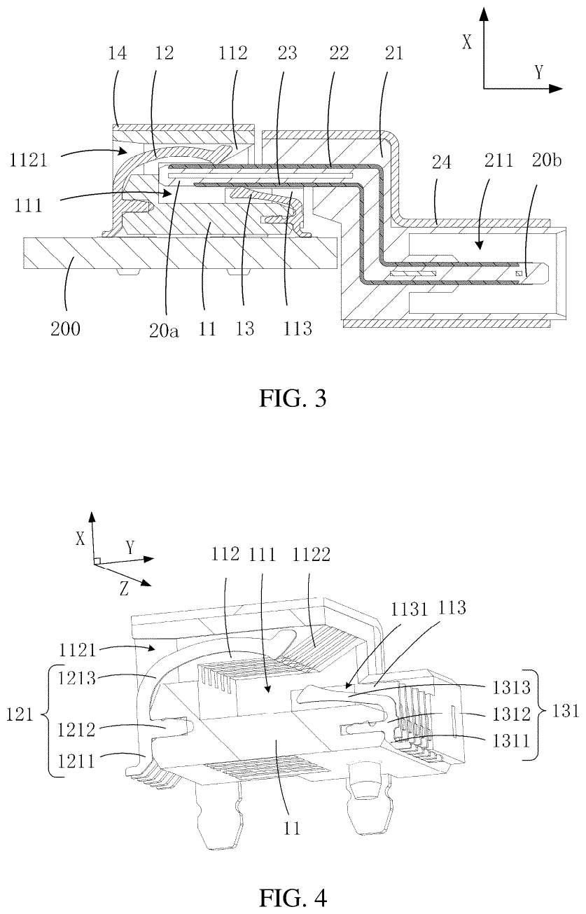

With respect to the base 11, referring to FIG. 3, and FIG. 4, a first slot 111, a first limiting boss 112, and a second limiting boss 113 are arranged on the base 11. Along a first direction X, the first limiting boss 112 and the second limiting boss 113 are spaced apart, such that the first slot 111 is at least partially formed between the first limiting boss 112 and the second limiting boss 113. The first terminal set 12 is arranged on the first limiting boss 112, and the second terminal set 13 is arranged on the second limiting boss 113. When the first end portion 20a of the adapter 20 is plugged into the first slot 111 along a second direction Y, the first terminal set 12 is directly docked with the second terminal set 22, and the second terminal set 13 is directly docked with the fourth terminal set 23. In this case, the first limiting boss 112 and the second limiting boss 113 are simultaneously docked with the first end portion 20a of the adapter 20, such that the first end portion 20a of the adapter 20 is limited along the first direction X. The first direction X is approximately perpendicular to the second direction Y.

In some embodiments, referring to FIG. 3 and FIG. 4, a plurality of first gap slots 1121 are arranged in the first limiting boss 112. The plurality of first gap slots 1121 arrayed along a third direction Z. Via the first gap slots 1121, the first slot 111 is communicated with an external environment, such that mounting of the first terminal set 12 is facilitated. The third direction Z, the first direction X, and the second direction Y are perpendicular to each other pairwise. The first terminal set 12 includes a plurality of first connection terminals 121. Each of the first connection terminals 121 is correspondingly arranged in one of the first gap slots 1121. The first connection terminal 121 includes a first pin portion 1211, a first securing portion 1212, and a first docking portion 1213 that are connected. The first securing portion 1212 is plugged onto the base 11. A first end of the first pin portion 1211 is connected to the first securing portion 1212, and a second end of the first pin portion 1211 extends out of the first slot 111, such that the second end is soldered to an external printed circuit board 200. The first docking portion 1213 is partially arranged in the first gap slot 1121. A first end of the first docking portion 1213 is connected to the first securing portion 1212, and a second end of the first docking portion 1213 protrudes from a surface of the first limiting boss 112 to be exposed in the first slot 111. The second end of the first docking portion 1213 is configured to be docked with a terminal on the third terminal set 22 to form an electrical signal connection.

In some embodiments, referring to FIG. 3 and FIG. 4, a plurality of second gap slots 1131 are arranged in the second limiting boss 113. The plurality of second gap slots 1131 arrayed along the third direction Z. Via the second gap slots 1131, the first slot 111 is communicated with an external environment, such that mounting of the second terminal set 13 is facilitated. The third direction Z, the first direction X, and the second direction Y are perpendicular to each other pairwise. The second terminal set 13 includes a plurality of second connection terminals 131. Each of the second connection terminals 131 is correspondingly arranged in one of the second gap slots 1131. The second connection terminal 131 includes a second pin portion 1311, a second securing portion 1312, and a second docking portion 1313 that are connected. The second securing portion 1312 is plugged onto the base 11. A first end of the second pin portion 1311 is connected to the second securing portion 1312, and a second end of the second pin portion 1311 extends out of the second slot 111, such that the second end is soldered to an external printed circuit board 200. The second docking portion 1313 is partially arranged in the second gap slot 1131. A first end of the second docking portion 1313 is connected to the second securing portion 1312, and a second end of the second docking portion 1313 protrudes from a surface of the second limiting boss 113 to be exposed in the first slot 111. The second end of the second docking portion 1313 is configured to be docked with a terminal on the fourth terminal set 23 to form an electrical signal connection.

It may be understood that the number of first connection terminals 121 in the first terminal set 12 may be equal to the number of first gap slots 1121, such that the first connection terminals 121 are assembled to the first gap slots 1121 in one-to-one correspondence. In other embodiments, the number of first gap slots 1121 may be greater than the number of first connection terminals 121, and excessive first gap slots 1121 are configured to communicate the first slots 111 to ambient air. When the first end portion 20a of the adapter 20 is plugged into the first slot 111, the first terminal set 12 and the third terminal set 22 may generate heat during transmission of electrical signals, and the excessive first gap slots 1121 may transfer the heat to the outside of the first slot 111, such that gas communication between the first slot 111 and the external environment is enhanced, and over-temperature inside the first slot 111 is avoided. Likewise, the number of second connection terminals 131 in the second terminal set 13 may be equal to the number of second gap slots 1131, such that the second connection terminals 131 are assembled to the second gap slots 1131 in one-to-one correspondence. In other embodiments, the number of second gap slots 1131 may be greater than the number of second connection terminals 131, and excessive second gap slots 1131 have the same function as the excessive first gap slots 1121.

In some embodiments, the first docking portion 1213 of the first connection terminal 121 is elastically deformable with respect to the first limiting boss 112. That is, the second end of the first docking portion 1213 is capable of moving up and down along the first direction X. Referring to FIG. 3, in an initial state, along the first direction X, a distance between the second end of the first docking portion 1213 and the second end of the second docking portion 1313 is less than a distance between the third terminal set 22 and the fourth terminal set 23 in the first end portion 20a of the adapter 20. When the first end portion 20a of the adapter 20 is plugged into the first slot 111, the second end of the first docking portion 1213 and the second end of the second docking portion 1313 are distracted along the first direction X. Since the first docking portion 1213 is elastically deformable, the second end of the first docking portion 1213 has a restoration trend and is tightly attached onto the third terminal set 22. This ensures an effective electrical connection between the first terminal set 12 and the third terminal set 22, and effectively reduces the probability that the first terminal set 12 is in poor contact with the third terminal set 22 during use of the electronic device.

Likewise, in some other embodiments, the second docking portion 1313 of the second connection terminal 131 is elastically deformable with respect to the second limiting boss 113. That is, the second end of the second docking portion 1313 is capable of moving up and down along the first direction X. Since the second docking portion 1313 is elastically deformable, the second end of the second docking portion 1313 has a restoration trend and is tightly attached onto the fourth terminal set 23. This ensures an effective electrical connection between the second terminal set 13 and the fourth terminal set 23, and effectively reduces the probability that the third terminal set 13 is in poor contact with the fourth terminal set 23 during use of the electronic device.

In some embodiments, an opening of the first slot 111 extends through the base 11 only along the second direction Y, such that the first end portion 20a of the adapter 20 is capable of moving along the second direction Y and is plugged into the first slot 111 to achieve an electrical connection. Upon completion of assembly of the electronic device, other elements or devices are also arranged in a region, on the printed circuit board 200, close to the adapter 10 and the adapter 20. That is, during future repair and replacement of parts of the electronic device, a limited space is left for movement of the adapter 20 along the second direction Y. In view of this problem during part replacement, referring to FIG. 2 and FIG. 4, the opening of the first slot 111 extends through the base 11 along both the first direction X and the second direction Y simultaneously. An inclined portion 1122 is arranged on the first limiting boss 112. The inclined portion 1122 is close to the opening of the first slot 111, such that along the second direction Y, the first limiting boss 112 and the second limiting boss 113 are staggered. The inclined portion 1122 is configured to enable the first end portion 20a of the adapter 20 to be plugged into the first slot 111 with respect to the connector 10, such that the other elements or devices are prevented from hindering plugging of the adapter 20. By the above structural configuration, the adapter 20 is capable of being plugged into or unplugged from the connector 10, such that replacement flexibility of the adapter 20 is enhanced, a space reserved for movement of the adapter 20 is reduced in the electronic device, and hence the electronic device is more structurally compact.

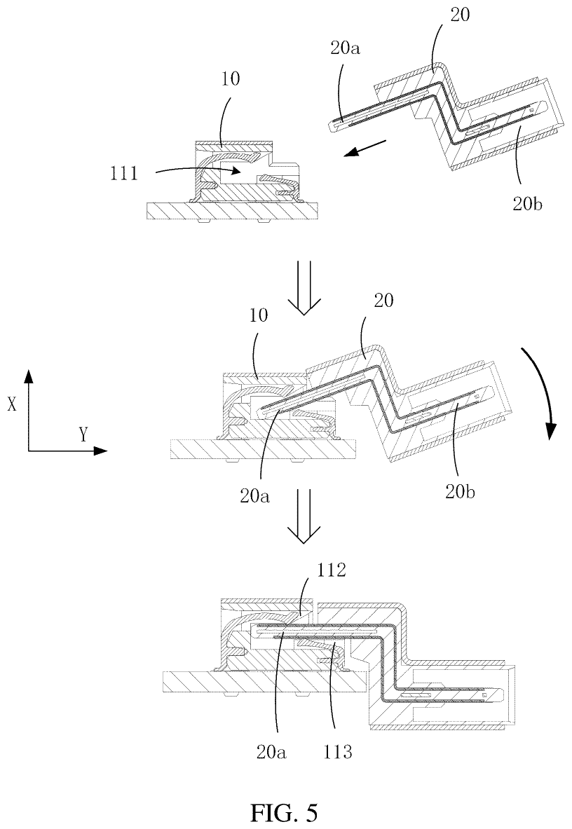

Specifically, referring to FIG. 5, during assembly, the adapter 20 is first inclined at a specific angle with respect to the connector 10, for example, any angle between 30° and 70°. Then, the first end portion 20a of the adapter 20 is plugged into the first slot 111, and then the adapter 20 is rotated at a suitable angle, such that the first limiting boss 112 and the second limiting boss 113 simultaneously limit the first end portion 20a along the first direction. As such, the adapter 20 is connected to the connector 10.

In some embodiments, referring to FIG. 2, a third limiting boss 114 and a fourth limiting boss 115 are further arranged on the base 11. Along the third direction Z, the third limiting boss 114 and the fourth limiting boss 115 are spaced apart on two sides of the second limiting boss 113. The third limiting boss 114 and the fourth limiting boss 115 jointly limit the first end portion 20a plugged into the first slot 111 along the third direction Z, such that the first terminal set 12 is accurately docked with the third terminal set 22, and the second terminal set 13 is accurately docked with the fourth terminal set 23.

In some embodiments, referring to FIG. 2 and FIG. 3, the connector 10 further includes a first securing housing 14. The first securing housing 14 is connected to the base 11. The first securing housing 14 is configured to secure the base 11 onto the external printed circuit board 200, such that the first terminal set 12 and the second terminal set 13 are stably connected to the printed circuit board 200.

With respect to the adapter 20, referring to FIG. 2 and FIG. 3, the adapter 20 includes a body 21, a third terminal set 22, and a fourth terminal set 23. Along the first direction X, the third terminal set 22 and the fourth terminal set 23 are respectively arranged at the top and bottom of the body 21. A second slot 211 is arranged in the body 21. The third terminal set 22 and the fourth terminal set 23 are partially positioned in the second slot 211, to form the second end portion 20b of the adapter 20. The second slot 211 is configured to allow quick positioning and plugging of an external plug into the second end portion 20b of the adapter 20.

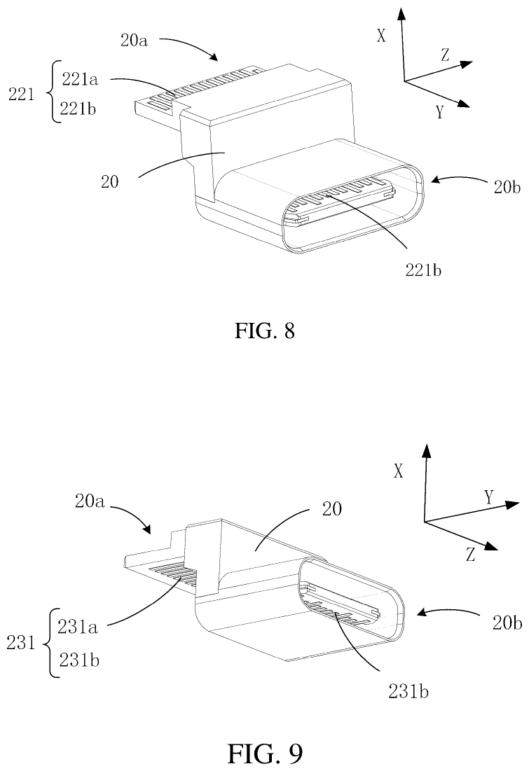

In some embodiments, referring to FIG. 8, the third terminal set 22 includes a plurality of third connection terminals 221. The plurality of third connection terminals 221 are spaced apart along the third direction Z. A first end 221a of the third connection terminal 221 is arranged at the first end portion 20a of the adapter 20, and a second end 221b of the third connection terminal 221 is arranged at the second end portion 20b of the adapter 20. When the adapter 20 is plugged into the connector 10, the first ends 221a of the third connection terminals 221 are docked with the first docking portions 1213 of the first connection terminals 121 in one-to-one correspondence.

In some embodiments, referring to FIG. 9, the fourth terminal set 23 includes a plurality of fourth connection terminals 231. The plurality of fourth connection terminals 231 are spaced apart along the third direction Z. A first end 231a of the fourth connection terminal 231 is arranged at the first end portion 20a of the adapter 20, and a second end 231b of the fourth connection terminal 231 is arranged at the second end portion 20b of the adapter 20. When the adapter 20 is plugged into the connector 10, the first ends 231a of the fourth connection terminals 231 are docked with the second docking portions 1313 of the second connection terminals 131 in one-to-one correspondence.

In some embodiments, referring to FIG. 2 and FIG. 3, the adapter 20 further includes a second securing housing 24. The second securing housing 24 is connected to the body 21. The second securing housing 24 is configured to secure the body 21 onto the external printed circuit board 200 when the adapter 20 and the connector 10 are connected, such that the adapter 20 is prevented from moving with respect to the connector 10, and hence the stability of the connection between the adapter 20 and the connector 10 is ensured.

It should be noted that the second securing housing 24 may be securely connected to the external printed circuit board 200 by any of adhesion, threaded connection, snap-fitting, and the like. As some examples, referring to FIG. 2, an extension portion 241 is formed on the second securing housing 24. A through hole 242 extending through the extension portion 241 are arranged in the extension portion 241. The through hole 242 is configured to allow a fastener to run through and is threaded to a threaded hole in the external printed circuit board 200, such that the second securing housing 24 is secured onto the printed circuit board 200.

In the embodiment where the adapter 20 is inclinedly plugged into the connector 10 at an angle, since when the adapter 20 and the connector 10 are connected, the first end portion 20a of the adapter 20 is limited along the first direction X by the first limiting boss 112 and the second limiting boss 113, and is limited along the third direction Z by the third limiting boss 114 and the fourth limiting boss 115. However, along the second direction Y, the adapter 20 and the connector 10 are still subject to relative movements. To improve the connection stability when the adapter 20 is plugged into the connector 10, a locking slot 1111 is arranged in an inner wall of the first slot 111, and a locking portion 212 is arranged at the first end portion 20a of the adapter 20. During plugging of the adapter 20 into the connector 10, the locking portion 212 is plugged into the locking slot 1111, and when the locking portion 212 is docked with a slot wall of the locking slot 1111, the relative movement of the adapter 20 with respect to the connector 10 along the second direction Y may be limited, and hence the adapter 20 is prevented from detaching from the connector 10 along the second direction Y.

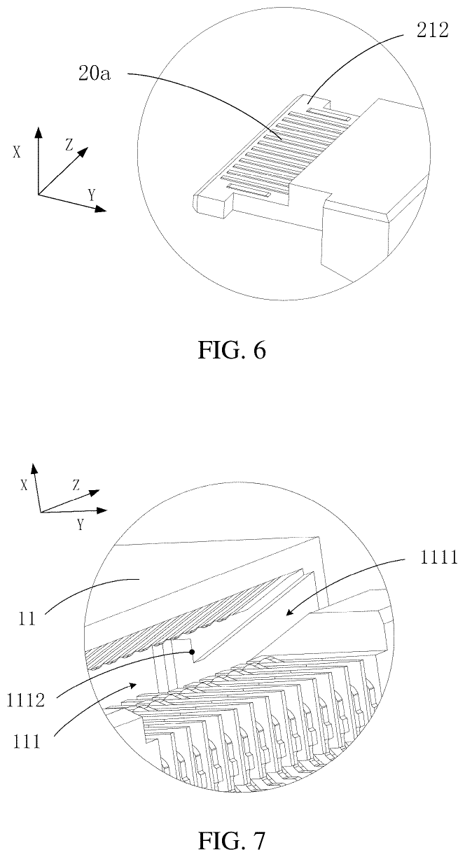

As an example, referring to FIG. 6 and FIG. 7 in combination with FIG. 3, along the third direction Z, an L-shaped locking slot 1111 recessed inward is arranged in the inner wall of the first slot 111, and a protruded locking portion 212 is arranged at the first end portion 20a of the adapter 20. During plugging of the adapter 20 into the connector 10, the locking portion 212 is plugged into the locking slot 1111. When the second end portion 20b of the adapter 20 moves downward to a horizontal state, the locking portion 212 moves upward until the locking portion 212 is docked with a slot wall 1112 of the locking slot 1111, such that the adapter 20 is limited along the second direction Y.

In addition, in the embodiment where the second securing housing 24 is arranged on the adapter 20 and the second securing housing 24 is secured to the external printed circuit board 200 by the extension portion 241, the shape of the locking slot 1111 may be adjusted, such that the locking portion 212 is docked with the slot wall 1112 of the locking slot 1111 after the adapter 20 moves at a specific distance along the second direction Y with respect to the connector 10. The above structure not only limits the adapter 20, but also achieves quick positioning of the through hole 242 in the extension portion 241 and the threaded hole 201 in the external printed circuit board 200, such that repetitive adjustment of the positions of the through hole and the threaded hole, and hence the assembly efficiency is effectively improved.

The present disclosure further provides some embodiments of an electronic device. The electronic device includes a printed circuit board 200 and the connector assembly 100 as described above. The connector 10 in the connector assembly 100 is soldered onto the printed circuit board 200, and the adapter 20 is detachably connected to the connector 10. It should be noted that upon completion of assembly of the electronic device, the printed circuit board 200 and the connector 10 are positioned inside the electronic device, and the adapter 20 is partially exposed outside the electronic device and is plug-connected to an external plug. During normal operation of the electronic device, the connector 10 remains connected to the adapter 20, almost with no need of plugging and unplugging. Therefore, a failure probability of the connector 10 is far lower than a failure probability of the adapter 20, and the connector 10 has a longer lifetime. Therefore, where the adapter 20 fails, it is necessary to remove and replace the failed adapter 20 only, which prolongs the lifetime of the electronic device. In addition, compared to the technical solutions in the related art that the adapter is directly soldered onto the printed circuit board, since the printed circuit board is more prone to damages during desoldering and removal of the adapter from the printed circuit board, the entire printed circuit board needs to be replaced, and hence the repair costs are increased. However, in the technical solutions of the present disclosure, no desoldering is needed, but the adapter is directly unplugged, which causes nearly no risks of damaging the printed circuit board. In addition, it is almost unnecessary to replace the printed circuit board, and hence the repair costs are greatly reduced. Furthermore, when the model of the adapter 20 changes due to evolution of the electronic device, it is only necessary to use an adapter 20 of a suitable model, and the original connector 10 is still adaptive to the newly replaced adapter 20. In this way, the manufacture costs due to update and evolution are greatly reduced.

The connector assembly 100 according to the present disclosure includes a connector 10 and an adapter 20. The connector 10 includes a base 11, a first terminal set 12, and a second terminal set 13. A first slot 111 is arranged in the base 11. The first terminal set 12 and the second terminal set 13 are both positioned in the first slot 111, and are both configured to be electrically connected to an external printed circuit board 200. The adapter 20 includes a body 21, a third terminal set 22, and a fourth terminal set 23. The third terminal set 22 and the fourth terminal set 23 are both arranged on the body 21. The adapter 20 includes a first end portion 20a and a second end portion 20b. The second end portion 20b is configured to be plug-connected to an external plug. When the first end portion 20a is plugged into the first slot 111, the first terminal set 12 is docked with the third terminal set 22, and the second terminal set 13 is docked with the fourth terminal set 23. By the above structure, where the adapter 20 fails, the adapter 20 only needs to be directly removed from the connector 10, with no need of desoldering, even less necessary to remove the printed circuit board 200 from the electronic device, such that the problem of complicated replacement of an interface of the electronic device and a low success rate of the replacement is effectively solved, and hence the efficiency and success rate of the replacement are improved.

Described above are exemplary embodiments of the present disclosure, but are not intended to limit the scope of the present disclosure. Any equivalent structure or equivalent process variation made based on the specification and drawings of the present disclosure, which is directly or indirectly applied in other related technical fields, fall within the scope of the present disclosure.

1. A connector assembly, comprising:
a connector and an adapter, wherein the connector comprises a base and a first terminal cluster, the first terminal being arranged on the base, and the adapter comprises a body and a second terminal cluster, the second terminal cluster being arranged on the body;
wherein when the adapter is plugged into the connector, the first terminal cluster is docked with the second terminal cluster.

2. The connector assembly according to claim 1, wherein
the first terminal cluster comprises a first terminal set and a second terminal set, wherein a first slot is arranged in the base, and the first terminal set and the second terminal set are both partially positioned in the first slot and are both configured to be electrically connected to an external printed circuit board; and
the second terminal cluster comprises a third terminal set and a fourth terminal set, wherein the third terminal set and the fourth terminal set are both arranged on the body, and the adapter comprises a first end portion configured to be plugged into the base and a second end portion configured to receive an external plug;
wherein when the first end portion of the adapter is plugged into the first slot, the first terminal set is docked with the third terminal set, and the second terminal set is docked with the fourth terminal set.

3. The connector assembly according to claim 2, wherein
a first limiting boss and a second limiting boss are arranged on the base, wherein along a first direction, the first limiting boss is spaced apart from the second limiting boss, and the first slot is at least partially positioned between the first limiting boss and the second limiting boss.

4. The connector assembly according to claim 3, wherein
a plurality of gap slots are arranged in the first limiting boss, and the first terminal set comprises a plurality of first connection terminals, wherein each of the first connection terminals is correspondingly arranged in one of the first gap slots and comprises a first pin portion, a first securing portion, and a first docking portion that are connected, the first pin portion extending through the first slot, the first securing portion being connected to the base, and the first docking portion being arranged in the first gap slot and partially protruding from a surface of the first limiting boss.

5. The connector assembly according to claim 4, wherein
a plurality of gap slots are arranged in the second limiting boss, and the second terminal set comprises a plurality of second connection terminals, wherein each of the second connection terminals is correspondingly arranged in one of the second gap slots and comprises a second pin portion, a second securing portion, and a second docking portion that are connected, the second pin portion extending through the first slot, the second securing portion being connected to the base, and the second docking portion being arranged in the second gap slot and partially protruding from a surface of the second limiting boss.

6. The connector assembly according to claim 5, wherein
the first docking portion is elastically deformable with respect to the first limiting boss, and/or the second docking portion is elastically deformable with respect to the second limiting boss.

7. The connector assembly according to claim 3, wherein
along a second direction, the first limiting boss and the second limiting boss are staggered, wherein the first direction is perpendicular to the second direction; and
an inclined portion is arranged on the first limiting boss, wherein the inclined portion is close to an opening of the first slot and is configured to cause the first end portion of the adapter to be plugged to the first slot at an angle.

8. The connector assembly according to claim 7, wherein
a third limiting boss and a fourth limiting boss are further arranged on the base, wherein along a third direction, the third limiting boss and the fourth limiting boss are spaced apart on two sides of the second limiting boss, wherein the first direction, the second direction, and the third direction are perpendicular to each other pairwise.

9. The connector assembly according to claim 1, wherein
the connector further comprises a first securing housing, wherein the first securing housing is connected to the base, and is configured to secure the base to an external printed circuit board.

10. The connector assembly according to claim 2, wherein
the third terminal set comprises a plurality of third connection terminals, wherein the plurality of third connection terminals are spaced apart along a third direction, and a first end of the third connection terminal is arranged at the first end portion of the adapter and a second end of the third connection terminal is arranged at the second end portion of the adapter.

11. The connector assembly according to claim 2, wherein
the fourth terminal set comprises a plurality of fourth connection terminals, wherein the plurality of fourth connection terminals are spaced apart along a third direction, and a first end of the fourth connection terminal is arranged at the first end portion of the adapter and a second end of the fourth connection terminal is arranged at the second end portion of the adapter.

12. The connector assembly according to claim 2, wherein
a second slot is arranged in the body, wherein the third terminal set and the fourth terminal set are partially positioned in the second slot to from the second end portion of the adapter, and the second slot is configured to allow positioning and plugging of an external plug into the second end portion of the adapter.

13. The connector assembly according to claim 1, wherein
the adapter further comprises a second securing housing, wherein the second securing housing is connected to the body, and is configured to secure the body to an external printed circuit board.

14. The connector assembly according to claim 2, wherein
a locking slot is arranged in an inner wall of the first slot, wherein a locking portion is arranged at the first end portion of the adapter, wherein the locking portion is plugged into the locking slot to restrict a relative movement of the adapter with respect to the connector along a second direction.

15. A connector assembly, comprising:
a connector and an adapter, wherein the connector is configured to be soldered to an external printed circuit board, and a first end portion of the adapter is configured to be docked with the adapter and a second end portion of the adapter is configured to be plug-and-play connected to an external plug.

16. An electronic device, comprising: the connector assembly as defined in claim 1.
